(19) United States
(12) Patent Application Publication
(10) Pub. No.: US 2005/0134422 A1
(43) Pub. Date: Jun. 23, 2005

(54) MEDIUM VOLTAGE FUSES: sheathed element reduces I2t energy during short-circuit operation

(76) Inventor: Richard J. Okuniewicz, Miami, FL (US)

Correspondence Address: DEN MAR TRANSIT ENGINEERING, INC., 10488 SW 211 STREET, MIAMI, FL, 33189, US

(21) Appl. No.: 10/707,542

(22) Filed: Dec. 19, 2003

(51) Int. Cl. H01H 85/04

(52) U.S. Cl. 337/159

(57) ABSTRACT

The disclosed medium voltage range, current limiting, backup fuse, comprises a housing filled with an arc-extinguishing media in a tubular housing of fiber resin or ceramic with conductive terminals at both ends. The high fault current spirally wound sheathed fusible elements of copper or silver are electrically connected to the end terminals and are wrapped on a mica or ceramic support. The elements can be single or multiple parallel wound for low to high nominal currents. The sheathed electrical element is of a series of homogeneous holes and notches distributed throughout to effectively cause the high-current 12t energy to be equally absorbed throughout the length of the element.

### CROSS REFERENCE TO RELATED APPLICATIONS

| | | | |
|---|---|---|---|
| 4,893,106 | January 1990 | Goldstein, et al | 337/159 |
| 4,973,932 | November 1990 | Krueger, et al | 337/164 |
| 5,148,140 | September 1992 | Goldstein | 337/158 |
| 5,604,474 | Febuary 1997 | Leach et al | 337/158 |

### BRIEF DESCRIPTION OF DRAWINGS

FIG. 1 is a longitudal cross-section of a current limiting, high/medium voltage, back-up fuse indicating the short-circuit monolithic high fault current element according to the invention and,

FIG. 2 is cutaway cross-section of the element showing more precisely the present invention.

### DESCRIPTION OF INVENTION

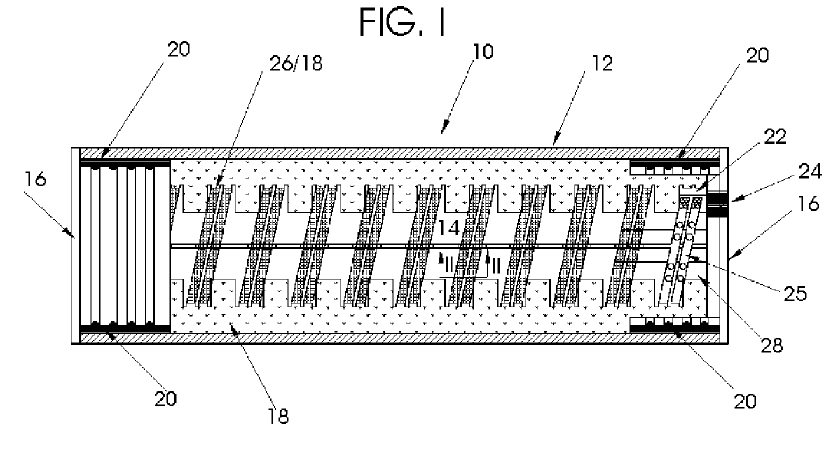

In FIG. 1, a monolithic ribbon-like fuse element 25 may be pure or alloys of silver, copper, zinc, cadmium or aluminum is sheathed within a Sodium Silicate material 26 and impregnated with beach/river bottom type silica sand 18. The current-limiting, high fault current element 25 has a plurality of pairs of opposed notches and geometrically spaced plurality of holes selected for desired current clearing characteristics. FIG. 1 shows two elements in parallel, however, in order to achieve larger current ratings, a multiple amount of paralleled elements may be used. The entire sheathed element of this invention is helically wound around a support 14 of mica, two pieces or ceramic and fixed with an end tube 28 at both ends to insure concentricity. The ribbon elements 25 are spot welded at both ends to an auxiliary contact 22, which is soldered to the conductive end caps 16 at the media-filling cap 24. The arc-quenching media is beach/river bed silica sand 18. Conductive terminal caps 16 are secured at the ends of the fiber/epoxy or ceramic tube housing 12 by means of an epoxy adhesive 20, which has a special curing process for maximum adhesion.

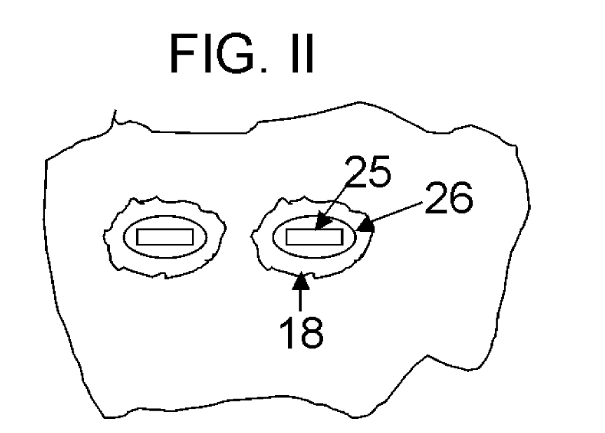

In FIG. 2 the invention is shown more clearly. The ribbon-element 25 is cleaned and coated with a heated liquid sheath of sodium silicate 26 (water glass) or other similar material having similar electrical and mechanical properties. The syrupy coating adheres to the ribbon-element protecting it from natural aging harmful oxidation. The combination is then impregnated with the silica sand 18 and then wound on the helical support 14 and kiln dried to attain the proper mechanical strength and flexibility.

After a successful high-current clearing operation, a uniform fulgarite is formed around the element. The clearing operation occurs very fast, less than 1/4 cycle or less than 4 msec. The arc quenching and 12t energy has been contained in a very small area.

### DETAIL OF INVENTION

The novelty of this invention is the sheathed dipped element, of which the sheathing compound is to have the following characteristics for improving the energy absorbing properties of the fuse:
Cannot carbonize: fusion point above 1000 C.
Cannot alter its chemical or physical properties with high heat
Good adhesive properties with sand and metals
Good mechanical resistance will not crack or break, be resilient under normal conditions. Have good tensile strength.
Cannot attack or change the properties of silver, copper or sand after extended contact with same.
Non-organic, neutral compound

One such material can be sodium silicate (water glass) Na2O(SiO2O)n (2<n<4).

The application of the non-organic material is critical to the proper functioning of this invention

The application process being to thoroughly (chemically) clean and dry the copper or silver element and then dip it into the hot liquefied material. Once the element is thickly coated with the hot liquefied material, it is passed through a fine uniform grained rounded silica sand that has no geometric sharp edges or cracks (type found on beaches and river beds). Note: fire occurs on edges of material. Cracks in materials cannot absorb large pressure as occurs during high-fault currents.
Once the sand has adhered to the sticky liquid, the element is wrapped on the support.
The entire support/element assembly is placed in a kiln and dried at 80 degrees C. for a period of 1 hour or until the material has solidified and is free of any organic materials.
The fuse is then assembled as normal

The fuse element will operate evenly, throughout its length, which in effect distributes the arcing energy uniformly.

An oxide coating on the elements can cause inconsistent behavior of the melting characteristics of the element/hole combination The fuse element will not oxidize because of the dipped sealant causing non-uniformity or weak spots that could not otherwise be determined or calculated. This in effect increases the speed of operation of the fuse, which lowers the 12t melting energy.

The element/sealant/sand combination is uniform thus reducing energy (heat) of operation (up to 50% less) and allowing for medium voltage fuses to be reduced in overall size, thus reducing material costs and lowering the overall price of the fuse.

The silica sand geometry is such as to provide for a large surface area to facilitate free electron recombination in the expanding arc, thereby reducing the extinction voltage. The captured electrons, now affixed to a much higher mass, are no longer effective in sustaining the discharge. Arc-quenching filler materials used for such purposes are well known in the art.

Furthermore, the sheathed high fault current element now acts as a heat radiator. The invention allows for cooler operation because the sheathed element will dissipate heat as in a diabatic process rather than the existing adiabatic standard. The area in which the element melts is very small, therefore difficult to dissipate heat. Adding the sheathing increases the relative melting area by about tenfold.

Test results have shown at least 30% decrease in I²t energy and as much as a 50% decrease. The reduction is mainly in the Peak Let Thru current which gives better equipment protection during high current fault situations.

1. An improved current limiting, high voltage, oil immersible fuse for interrupting high fault currents:
(a) a tubular insulating casing and an inert granular arc-quenching material of high dielectric strength within said casing;
(b) one or more ribbon-type fuse elements being electrically connected in parallel when more than one is used. Adding more parallel combinations is for increasing nominal current ranges.
(c) a pair of hermetically sealed end caps that electrically connect said elements
(d) by means of solder/spot welding that completes the electrical connection.

2. An improved fuse as stated in claim 1 whereas said high fault current fuse elements being coated and sheathed in a gel of sodium silicate and sand compound.

3. An improved fuse as stated in claim 1 and 2 with a dielectric support positioned in said casing between said terminals wherein said sheathed fuse element is spirally wound around said dielectric support.

4. An improved fuse as stated in claim 3 whereas the sheathed element is kiln dried on the dielectric support after mounting.

5. An improved fuse as stated in claim 1 whereas the inert arc-quenching material is silica sand and completely fills said casing. Sand that has been taken from beaches or river beds that does not exhibit any sharp edges or cracks.

6. An improved fuse as stated in claim 1 whereas the high fault current element materials are pure or alloys of silver, copper, zinc, cadmium, aluminum or similar alloys thereof.

7. An improved fuse as stated in claim 1 whereto the said tubular insulating casing is a fiber laced glass/epoxy composite.

8. An improved fuse as stated in claim 3 whereas the dielectric element support is a mica or ceramic material.
